(19) United States
(12) Patent Application Publication
(10) Pub. No.: US 2026/0367842 A1
(43) Pub. Date: Nov. 19, 2026

(54) PRINTING APPARATUS, PRINTING SYSTEM, PRINTING METHOD, AND NON-TRANSITORY COMPUTER-READABLE RECORDING MEDIUM THEREFOR

(71) Applicant: BROTHER KOGYO KABUSHIKI KAISHA, Nagoya (JP)

(72) Inventor: Shunsuke Yamamoto, Okazaki (JP)

(21) Appl. No.: 19/631,318

(22) Filed: Mar. 27, 2026

(30) Foreign Application Priority Data
May 15, 2025 (JP) 2025-081761

(51) Int. Cl. G06F 3/12

(52) U.S. Cl. CPC G06F 3/1205; G06F 3/1257

(57) ABSTRACT

A printing apparatus includes a printer engine, an image data obtaining unit configured to obtain image data, a print setting information obtaining unit configured to obtain print setting information, a receiving unit configured to receive a selection among first and second settings, and a printing controller. In a case where mixed-size image data and the print setting information are obtained and the first setting is selected, the printer engine prints the first page image with the first media size and the second page image with the second media size. In a case where the mixed-size image data and the print setting information are obtained and the second setting is selected, the printer engine prints each of the two or more page images represented by the mixed-size image data respectively on different output media of the media size indicated by the setting value.

### REFERENCE TO RELATED APPLICATIONS

This application claims priority under 35 U.S.C. §119 from Japanese Patent Application No. 2025-081761 filed on May 15, 2025. The entire subject matter of the application is incorporated herein by reference.

### BACKGROUND ART

The present specification relates to techniques for printing an image.

Conventionally, a printer has been used to print images. Various techniques for printing an image by using a printer have been proposed. For example, it is known that print data is generated by a general-purpose print service such as Internet Printing Protocol (IPP).

A printer can print an image on media of various sizes such as A4 size and Letter size. A media size can be designated by various methods. For example, print setting information for printing can indicate a media size. In addition, a media size can be associated with image data. For instance, image data of various formats such as Portable Document Format (PDF) may include data indicating a media size. In this regard, there has been room for improvement in using an appropriate media size for printing.

The present application discloses techniques that make it possible to print an image on an output medium having an appropriate media size.

### SUMMARY

According to aspects of the present disclosure, a printing apparatus includes a printer engine, an image data obtaining unit configured to obtain image data representing one or more page images to be printed, a print setting information obtaining unit configured to obtain print setting information indicating one or more setting items for printing, a receiving unit configured to receive a selection of which setting is to be used among a first setting and a second setting, and a printing controller configured to cause the printer engine to execute printing based on the image data and the print setting information. In a case where mixed-size image data and the print setting information are obtained and the first setting is selected, the mixed-size image data being the image data representing two or more page images including a first page image associated with a first media size and a second page image associated with a second media size different from the first media size, the print setting information including a setting value of an output medium setting, which is a setting item indicating a media size common to respective page images to be printed, the printing controller causes the printer engine to print the first page image on an output medium of the first media size and to print the second page image on an output medium of the second media size. In a case where the mixed-size image data and the print setting information are obtained and the second setting is selected, the print setting information including the setting value of the output medium setting, the printing controller causes the printer engine to print each of the two or more page images represented by the mixed-size image data respectively on respective output media of the media size indicated by the setting value of the output medium setting, the respective output media being mutually different.

According to aspects of the present disclosure, a printing method for printing using a printing apparatus includes obtaining image data representing one or more page images to be printed, obtaining print setting information indicating one or more setting items for printing, receiving a selection of which setting is to be used among a first setting and a second setting, causing a printer engine of the printing apparatus to execute printing based on the image data and the print setting information, in a case where mixed-size image data and the print setting information are obtained and the first setting is selected, the mixed-size image data being the image data representing two or more page images including a first page image associated with a first media size and a second page image associated with a second media size different from the first media size, the print setting information including a setting value of an output medium setting, which is a setting item indicating a media size common to respective page images to be printed, causing the printer engine to print the first page image on an output medium of the first media size and to print the second page image on an output medium of the second media size, and in a case where the mixed-size image data and the print setting information including the setting value of the output medium setting are obtained and the second setting is selected, causing the printer engine to print each of the two or more page images represented by the mixed-size image data respectively on respective output media of the media size indicated by the setting value of the output medium setting, the respective output media being mutually different.

According to aspects of the present disclosure, a non-transitory computer-readable recording medium contains computer-executable instructions that are executable by a controller of a printing apparatus. The computer-executable instructions are configured to, when executed by the controller, cause the printing apparatus to perform obtaining image data representing one or more page images to be printed, obtaining print setting information indicating one or more setting items for printing, receiving a selection of which setting is to be used among a first setting and a second setting, causing a printer engine to execute printing based on the image data and the print setting information, in a case where mixed-size image data and the print setting information are obtained and the first setting is selected, the mixed-size image data being the image data representing two or more page images including a first page image associated with a first media size and a second page image associated with a second media size different from the first media size, the print setting information including a setting value of an output medium setting, which is a setting item indicating a media size common to respective page images to be printed, causing the printer engine to print the first page image on an output medium of the first media size and to print the second page image on an output medium of the second media size, and in a case where the mixed-size image data and the print setting information including the setting value of the output medium setting are obtained and the second setting is selected, causing the printer engine to print each of the two or more page images represented by the mixed-size image data respectively on respective output media of the media size indicated by the setting value of the output medium setting, the respective output media being mutually different.

According to aspects of the present disclosure, a printing system includes, a printing apparatus and a terminal device. An operating system including a standard driver for printing is installed in the terminal device. The terminal device, by the standard driver, realizes functions of a providing unit configured to provide a print setting screen, an input receiving unit configured to receive, in the print setting screen, input of one or more setting items for printing, the input receiving unit being configured not to receive input of a media size for each page image to be printed and configure to receive input of an output medium setting which is a setting item indicating a media size common to respective page images to be printed, a print setting information transmitting unit configured to transmit print setting information indicating the one or more input setting items to the printing apparatus, the print setting information including a setting value of the output medium setting, and an image data transmitting unit configured to transmit image data representing one or more page images to be printed to the printing apparatus. The printing apparatus comprises a printer engine, a receiving unit configured to receive a selection of which setting is to be used among a first setting and a second setting, and a printing controller configured to cause the printer engine to execute printing based on the image data and the print setting information received from the terminal device. In a case where mixed-size image data and the print setting information are obtained and the first setting is selected, the mixed-size image data being the image data representing two or more page images including a first page image associated with a first media size and a second page image associated with a second media size different from the first media size, the print setting information including the setting value of the output medium setting, the printing controller causes the printer engine to print the first page image on an output medium of the first media size and to print the second page image on an output medium of the second media size. In a case where the mixed-size image data and the print setting information are obtained and the second setting is selected, the print setting information including the setting value of the output medium setting, the printing controller causes the printer engine to print each of the two or more page images represented by the mixed-size image data respectively on respective output media of the media size indicated by the setting value of the output medium setting, the respective output media being mutually different.

According to aspects of the present disclosure, a printing method for printing includes transmitting print setting information indicating one or more setting items to a printing apparatus, the print setting information including a setting value of an output medium setting, transmitting image data representing one or more page images to be printed to the printing apparatus, receiving a selection of which setting is to be used among a first setting and a second setting, causing a printer engine of the printing apparatus to execute printing based on the image data and the print setting information received by the printing apparatus, in a case where mixed-size image data and the print setting information are obtained and the first setting is selected, the mixed-size image data being the image data representing two or more page images including a first page image associated with a first media size and a second page image associated with a second media size different from the first media size, the print setting information including the setting value of the output medium setting, causing the printer engine to print the first page image on an output medium of the first media size and to print the second page image on an output medium of the second media size, and in a case where the mixed-size image data and the print setting information are obtained and the second setting is selected, the print setting information including the setting value of the output medium setting, causing the printer engine to print each of the two or more page images represented by the mixed-size image data respectively on respective output media of the media size indicated by the setting value of the output medium setting, the respective output media being mutually different.

It should be noted that the techniques disclosed in the present application can be implemented in various forms. For example, the techniques can be realized as a printer, as a terminal device, as a printing system including the printer and the terminal device, as a method performed by the printer, as a method performed by the terminal device, as a method performed by the printing system, as a computer program for implementing functions of such apparatuses or methods, or as a recording medium (for example, a non-transitory recording medium) storing the computer program.

### BRIEF DESCRIPTION OF THE DRAWINGS

FIG. 1 is a block diagram illustrating an example of a system.

FIGS. 2A–2C are diagrams illustrating examples of images to be processed.

FIG. 3 is a sequence diagram illustrating an example of a printing process.

FIG. 4 is a sequence diagram illustrating an example of a printing process.

FIG. 5 is a diagram illustrating an example of a print setting screen.

FIG. 6 is a diagram illustrating an example of a selection screen.

FIG. 7 is a flowchart illustrating an example of a printer process.

FIG. 8 is a flowchart illustrating an example of a printer process.

FIG. 9 is a flowchart illustrating an example of a setting process.

FIG. 10 is a diagram illustrating an example of a printer process.

FIG. 11 is a flowchart illustrating another example of a setting process.

FIG. 12 is a diagram illustrating an example of a printer process.

FIG. 13 is a flowchart illustrating an example of a mode selection process.

FIG. 14 is a diagram illustrating an example of a mode selection screen.

FIG. 15 is a diagram illustrating an example of a printer process.

### DESCRIPTION

### A1. Apparatus Configuration

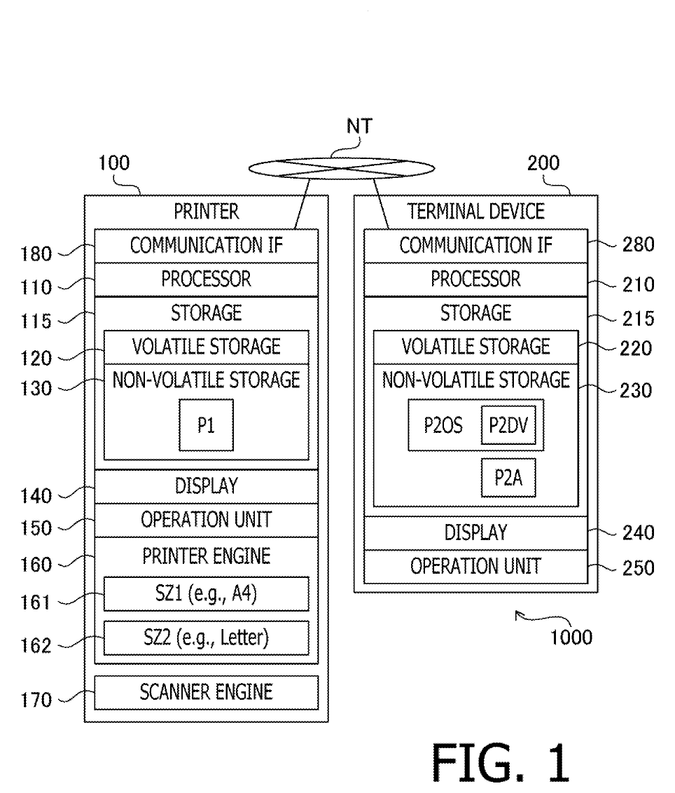

FIG. 1 is a block diagram illustrating an example of a system. A printing system 1000 includes a printer 100 and a terminal device 200. The printer 100 and the terminal device 200 are connected to a network NT. The network NT may include a so-called local area network. The network NT may also include the Internet. Hereinafter, the printing system 1000 is also simply referred to as the system 1000.

The printer 100 includes a processor 110, a storage 115, a display 140, an operation unit 150, a printer engine 160, a scanner engine 170, and a communication interface 180. These elements are connected to each other via a bus (not shown). The storage 115 includes a volatile storage 120 and a non-volatile storage 130.

The display 140 is a device configured to display images, such as a liquid crystal display or an organic EL (OLED) display. The operation unit 150 is a device configured to receive operations by a user, such as buttons, levers, or a touch panel disposed to overlap the display 140. The display 140 and the operation unit 150 may form a so-called touch screen. A user can input various requests and instructions to the printer 100 by operating the operation unit 150. The display 140 may present operation elements such as buttons or sliders, and the presented elements may be operated through operations of the operation unit 150.

The printer engine 160 is a device that prints an image on a sheet such as paper. The printer engine 160 may be, for example, an electrophotographic printer engine or an inkjet printer engine. The electrophotographic printer engine may be a so-called laser printer engine. In the present embodiment, the printer engine 160 is assumed to be capable of printing a color image using four colorants—cyan, magenta, yellow, and black.

In the present embodiment, the printer engine 160 includes two trays 161 and 162. The trays 161 and 162 are configured to accommodate sheets having different sizes SZ1 and SZ2, respectively. For example, a first size SZ1 of sheets accommodated in the first tray 161 may be A4 size, and the second size SZ2 of sheets accommodated in the second tray 162 may be Letter size. As described later, the printer 100 prints an image using a sheet having a media size specified for printing.

The scanner engine 170 is a device that optically reads a target such as a document. The scanner engine 170 includes an optical sensor (not shown). By optically reading the target, the scanner engine 170 generates scan data of a scan image representing the read target. A printer including the scanner engine 170 is also referred to as a multifunction peripheral.

The communication interface 180 is an interface for communicating with another device. The communication interface 180 includes, for example, at least one of a USB interface, a wired LAN interface, a wireless interface compliant with IEEE 802.11, and a short-range wireless communication interface. The short-range wireless communication interface may include a Bluetooth (Registered Trademark) interface or a Near Field Communication (NFC) interface. In the present embodiment, the communication interface 180 is connected to the network NT.

The processor 110 is a device configured to perform a data process and is, for example, a Central Processing Unit (CPU) or a System on a Chip (SoC). The volatile storage 120 is, for example, Dynamic Random Access Memory (DRAM), and the non-volatile storage 130 is, for example, flash memory. The non-volatile storage 130 stores data of a program P1. The program P1 is a program for controlling the printer 100. The data of the program P1 is stored in the non-volatile storage 130 by a manufacturer of the printer 100 at the time of manufacture. The program P1 may alternatively be downloaded from a server (not shown).

In the present embodiment, the program P1 is configured to make available, as a print mode, a so-called pass-through mode. The pass-through mode is a print mode in which image data used for a printing process is transmitted as is to the printer 100. In the present embodiment, the printer 100 is assumed to receive image data in Portable Document Format (PDF) in the pass-through mode. The processor 110, in accordance with the program P1, uses the PDF image data to generate print data for controlling the printer engine 160.

A process for generating the print data includes, for example, a rasterization process, a color conversion process, and a halftoning process. The rasterization process is a process of using the image data to generate raster data at a resolution for printing. A color space of the raster data may be the same as a color space of the image data. For example, the color space of the raster data may be an RGB color space. The color conversion process is a process of converting the color space of the raster data to a colorant color space. The colorant color space is a color space represented by color components of colorants used by the printer engine 160. The colorant color space may be, for example, a CMYK color space. The halftoning process is a process of using the color converted raster data to generate print data indicating, for each colorant and for each pixel, a dot formation state. A method for the halftoning process may be, for example, an error diffusion method or a dithering method.

The processor 110 controls the printer engine 160 in accordance with the print data, thereby printing, on a sheet, a page image represented by the image data.

The PDF image data can set a media size for each page image. The program P1 includes a program for a function of printing each page image on a medium having a corresponding size. For example, the processor 110, by executing pass-through printing, can print a first page image on a medium of Letter size and can print a second page image on a medium of A4 size. Hereinafter, a process of printing respective ones of a plurality of page images on media of mutually different sizes is referred to as “mixed-size printing.”

The program P1 may further be configured, as a print mode, to process a print job in a mode that uses image data generated by a printer driver. Hereinafter, this mode is also referred to as a client mode. Image data received in the client mode is not limited to PDF data and may be image data described in various Page Description Languages (PDLs).

A terminal device 200 is a device capable of communicating with another device such as the printer 100. The terminal device 200 may be, for example, a personal computer, a smartphone, or a tablet computer.

The terminal device 200 includes a processor 210, a storage 215, a display 240, an operation unit 250, and a communication interface 280. These elements are connected to each other via a bus (not shown). The storage 215 includes a volatile storage 220 and a non-volatile storage 230.

The display 240 is a device configured to display images. The operation unit 250 is a device configured to receive operations performed by a user. The communication interface 280 is an interface for communicating with another device. Respective configurations of the display 240, the operation unit 250, and the communication interface 280 may be various configurations similar to those described above for the display 140, the operation unit 150, and the communication interface 180 of the printer 100.

The processor 210 is a device configured to perform a data process and is, for example, a CPU or a System on a Chip (SoC). A volatile storage 220 is, for example, DRAM, and a non-volatile storage 230 is, for example, flash memory. The non-volatile storage 230 stores data of an operating system P2OS and data of a document application P2A. The operating system P2OS and the document application P2A are programs executed by the processor 210.

The operating system P2OS may be various systems. In the present embodiment, the operating system P2OS is Windows (Registered Trademark) by Microsoft Corporation. The operating system P2OS may be installed in the terminal device 200 by a manufacturer of the terminal device 200 or by a user of the terminal device 200.

The operating system P2OS includes a class driver P2DV. The class driver P2DV is a class driver for Internet Printing Protocol (IPP). The class driver P2DV is a standard driver commonly usable with multiple types of printers provided by different manufacturers. The standard driver can cause the printer to print an image without installing a dedicated printer driver for the printer provided by a manufacturer of the printer. The standard driver can obtain various print settings, such as a media size and a number of copies, through a standard print setting screen.

The operating system P2OS may be iOS (Registered Trademark), and the standard driver may be a program that provides an AirPrint (Registered Trademark) function. Alternatively, the operating system P2OS may be Android (Registered Trademark), and the standard driver may be a program that provides a Mopria (Registered Trademark) printing function.

A document application P2A is an application that processes various document data such as PDF image data and text data. Hereinafter, the document application P2A is also referred to as a document app P2A. The document app P2A may be installed in the terminal device 200 by a manufacturer of the terminal device 200 or by a user of the terminal device 200. Alternatively, the document app P2A may be included in the operating system P2OS.

### A2. Printing Process

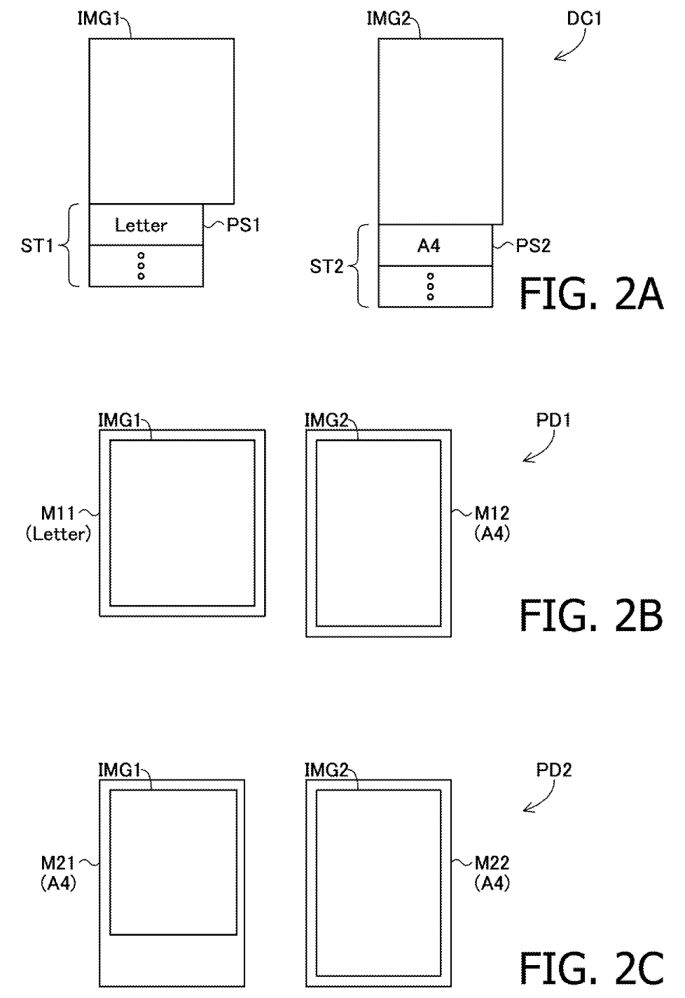

FIGS. 2A-2C are diagrams illustrating examples of images to be processed. In the present embodiment, a user uses the document app P2A to cause the printer 100 to print a plurality of page images represented by image data. Hereinafter, image data used for a printing process is referred to as “input image data.” In the present embodiment, the input image data is assumed to be PDF image data, and the user is assumed to select a pass-through mode. A method for selecting the pass-through mode may vary. For example, the user may select the pass-through mode through device settings of the printer 100 managed by the operating system P2OS. Alternatively, the user may select the pass-through mode through device settings of the printer 100 managed by the class driver P2DV.

FIG. 2A illustrates a page image represented by input image data. In the present embodiment, input image data DC1 represents two page images IMG1 and IMG2. The PDF image data can represent page settings, which are settings for each page. The page settings are also referred to as attributes. The page settings may include a media size. As the media size, for example, a value associated with a key called “MediaBox” may be used. The MediaBox represents a rectangle that defines a boundary of a physical medium for displaying or printing a page image. Specifically, the MediaBox represents positions of four sides of the rectangle, that is, a height and a width.

In the example of FIG. 2A, a first page setting ST1 associated with a first page image IMG1 includes a media size PS1 that indicates Letter size. A second page setting ST2 associated with a second page image IMG2 includes a media size PS2 that indicates A4 size. Thus, the media size may differ for each page.

The PDF image data may indicate a media size common to a plurality of page images. When a page setting associated with a particular page image among the plurality of page images includes a media size, the media size included in the page setting takes precedence over the common media size.

A media size indicated by PDF image data is associated with the image data without using a print setting screen. Hereinafter, a media size associated with image data without using the print setting screen is referred to as a “document size.” In the present embodiment, the document size may indicate a media size for each page image.

When the pass-through mode is selected, the printer 100 shown in FIG. 1 prints each page image in accordance with the document size. For example, when the input image data DC1 of FIG. 2A is used for printing, the printer 100 prints the first page image IMG1 on a Letter size sheet obtained from the second tray 162, and prints the second page image IMG2 on an A4 size sheet obtained from the first tray 161.

Hereinafter, a process of printing respective ones of a plurality of page images on an output medium having a size indicated by the document size is referred to as “document size printing.” An output medium used for printing is hereinafter also simply referred to as “a medium.” In the present embodiment, a media size indicated by the document size may differ among the plurality of page images. By executing the document size printing, mixed-size printing may be executed. A process of printing each page image in accordance with the media size indicated by PDF image data is an example of the document size printing.

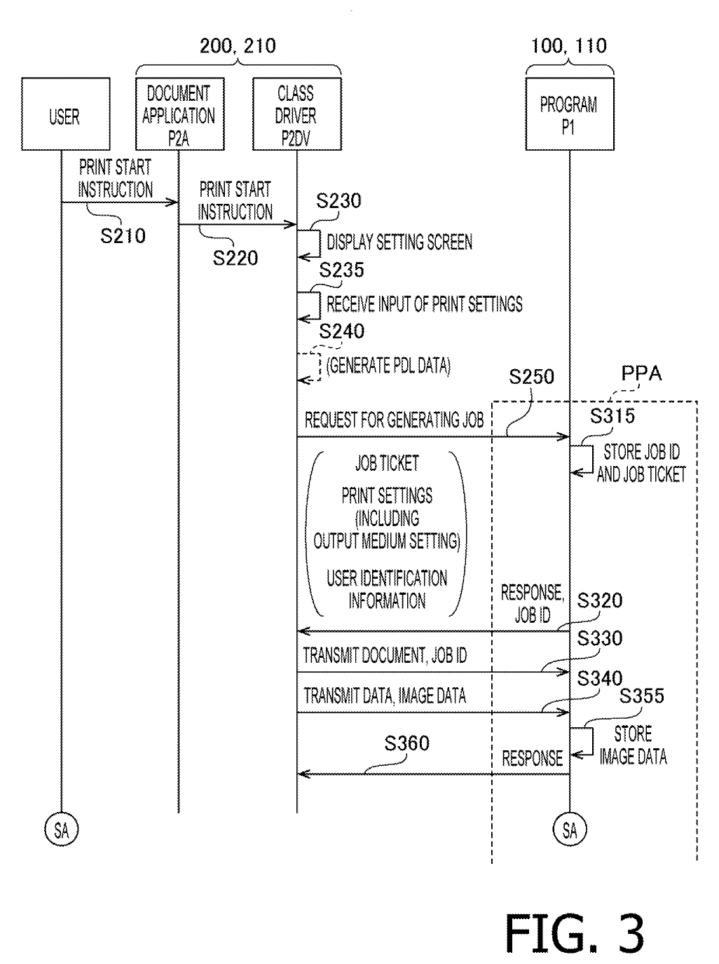

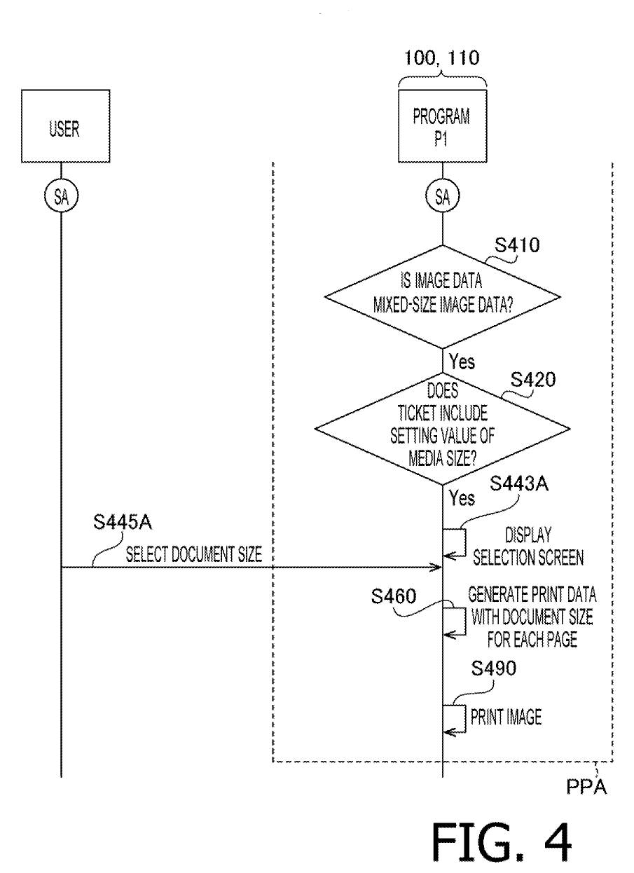

FIGS. 3 and 4 are sequence diagrams illustrating examples of a printing process. FIG. 4 illustrates processes subsequent to FIG. 3. In the diagrams, the programs P2A, P2DV, and P1 are indicated. A processor 210 of the terminal device 200 executes processes in accordance with the programs P2A and P2DV. Hereinafter, execution of processes by the processor 210 in accordance with a document application P2A is also expressed as “the document application P2A executes the processes.” The same applies to the class driver P2DV. The processor 110 of the printer 100 executes processes in accordance with a program P1. Hereinafter, the processor 110 of the printer 100 is also referred to as “the printer processor 110.”

Here, it is assumed that the input image data DC1 of FIG. 2A has already been opened by the document application P2A. In step S210 of FIG. 3, a user inputs an instruction to start printing to the document application P2A by operating an operation unit 250 of the terminal device 200. In step S220, the document application P2A supplies the instruction to start printing to a class driver P2DV. In step S230, the class driver P2DV causes a display 240 to display a print setting screen that allows a user to select print settings to be used for printing from among available print settings. Hereinafter, the print setting screen is also referred to simply as “a setting screen.”

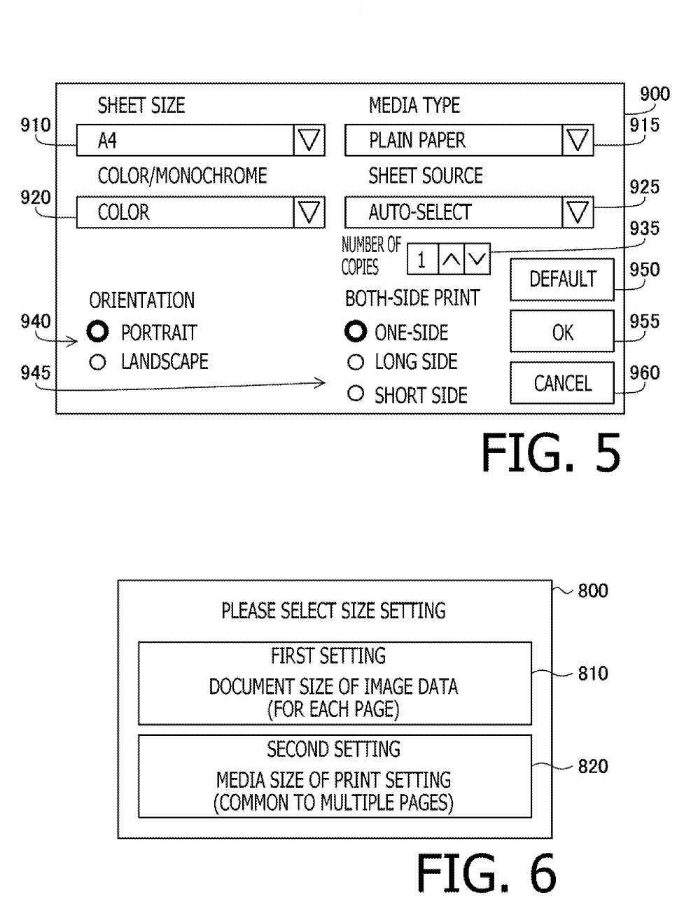

FIG. 5 is a diagram illustrating an example of the print setting screen. A print setting screen 900 includes various operation elements such as drop-down menus and buttons. A user can edit print settings by operating the operation elements. Hereinafter, the print setting screen 900 is also referred to simply as “the print setting screen 900.”

The print setting screen 900 includes the drop-down menus 910, 915, 920, and 925, a spinner 935, radio button groups 940 and 945, and buttons 950, 955, and 960. Hereinafter, the drop-down menus 910, 915, 920, and 925 are also referred to simply as “the menus 910, 915, 920, and 925.”

The menu 910 allows a user to select one sheet size from a list of sheet sizes. In the present embodiment, the list includes “A4” and “Letter.”

The menu 915 allows a user to select one media type from a list of media types. The list includes, for example, “plain paper” and “glossy paper.”

The menu 920 allows a user to select one color mode from a list of color modes. In the present embodiment, the list includes “color” and “monochrome.”

The menu 925 allows a user to select one paper source from a list of paper sources. In the present embodiment, the list includes “automatic selection,” “the first tray 161,” and “the second tray 162.”

The spinner 935 allows a user to set a number of copies to be printed.

The radio button group 940 allows a user to select an orientation of an image from “portrait” and “landscape.”

The radio button group 945 allows a user to select a duplex printing (i.e., both-side printing) setting from “one side,” “long side,” and “short side.” The “long side” is duplex printing in which a hinge for page turning corresponds to a long edge, and the “short side” is duplex printing in which the hinge corresponds to a short edge.

The button 950 is a button for returning changeable settings to predetermined initial settings.

The button 955 is a button for finishing the settings and executing printing.

The button 960 is a button for interrupting the printing process.

The class driver P2DV uses print settings that are previously associated with the printer 100 as print settings selectable through the print setting screen 900. Alternatively, the class driver P2DV may determine the print settings selectable through the print setting screen 900 by using capability information. The capability information is information representing all functions made available by a printer. The capability information may represent various information, such as a list of available media sizes and a list of available color modes. In the present embodiment, it is assumed that the list of available media sizes includes “A4” and “Letter,” and that the list of available color modes includes “color” and “monochrome.”

After S220 of FIG. 3 and before S230, the class driver P2DV may transmit to the printer 100 a request for the capability information. In response to the request, the printer processor 110 may transmit capability information data of the printer 100 to the terminal device 200. In S230, the class driver P2DV may cause the display 240 to display a print setting screen representing a plurality of available print settings indicated by the capability information.

In S235, the class driver P2DV receives input of print settings through the print setting screen 900. In the present embodiment, a user can operate respective operation elements of the print setting screen 900 by operating the operation unit 250 of the terminal device 200 of FIG. 1. The user can input various print settings by operating the operation elements.

After editing of the print settings is completed, a user inputs a print execution instruction. In the present embodiment, the button 955 of FIG. 5 is a button for inputting the print execution instruction. By operating the button 955, the user inputs the print execution instruction. Thereafter, S235 ends.

After S235, the class driver P2DV starts processing for executing printing. As described later, S240 may be executed when the print mode is a client mode.

In S250, the class driver P2DV transmits to the printer 100 a request for job generation. In association with this request, the class driver P2DV transmits data of a job ticket to the printer 100. The job ticket represents print settings of a print job supplied to the printer 100. The class driver P2DV generates a job ticket representing all print settings set through the print setting screen 900 of FIG. 5. The print settings indicate one or more setting items for printing. In the present embodiment, the print settings indicate multiple setting items including a sheet size selected via the menu 910. Hereinafter, a print setting that indicates the sheet size is referred to as an “output medium setting.” A setting value of the output medium setting indicates a sheet size selected via the menu 910. The job ticket is also referred to simply as a “ticket.”

In the present embodiment, the class driver P2DV further transmits, in association with the job ticket, data of user identification information to the printer 100. The user identification information is identification information of a user who proceeds with the printing process. The user identification information may be various kinds of information for identifying the user. For example, an operating system P2OS of the terminal device 200 may require a user to log in to use the terminal device 200, in which case the user identification information may be identification information of the logged in user. Further, the printer 100 may permit use of the printer 100 to a user registered in advance in the printer 100. The user identification information may be identification information of the user registered in the printer 100. The class driver P2DV may receive input of the user identification information through the setting screen of S230 or through another input screen.

In S315, the printer processor 110 generates a job ID associated with the job ticket. The printer processor 110 stores, in the storage 115, the job ticket data and the job ID data in association with each other. The data may be stored, for example, in the non-volatile storage 130.

In S320, the processor 110 transmits to the terminal device 200 a response to the request for job generation. This response includes data of the job ID.

In response to receipt of the response in S320, the class driver P2DV performs document transmission. The document transmission includes S330 and S340. In S330, the class driver P2DV transmits the job ID data to the printer 100. After completion of transmission of the job ID data, in S340, the class driver P2DV transmits image data to the printer 100. When the print mode is the pass-through mode, the class driver P2DV transmits to the printer 100 input image data such as the input image data DC1 of FIG. 2A. The input image data transmitted in S340 is an example of target image data that is image data to be printed.

After completion of receipt of the image data, in S355, the printer processor 110 stores the received image data in the storage 115 in association with the job ticket associated with the job ID obtained in S330. The data may be stored, for example, in the non-volatile storage 130.

After S355, in S360, the printer processor 110 transmits, to the terminal device 200, a response to the document transmission. In the present embodiment, upon receipt of this response, processing by the class driver P2DV ends.

In S410 of FIG. 4, the printer processor 110 determines whether the image data is mixed-size image data. The mixed-size image data is image data that represents a plurality of page images respectively associated with mutually different media sizes. The input image data DC1 of FIG. 2A represents a first page image IMG1 and a first media size PS1 associated with the first page image IMG1, and a second page image IMG2 and a second media size PS2 associated with the second page image IMG2. The second media size PS2 differs from the first media size PS1. The input image data DC1 is an example of the mixed-size image data. Hereinafter, the mixed-size image data is also referred to simply as “mixed-size data.”

FIG. 4 illustrates processing when a determination result in S410 is Yes. Processing when the determination result in S410 is No will be described later.

When the image data is the mixed-size data (S410: Yes), in S420, the printer processor 110 determines whether the job ticket includes a setting value of a media size. The job ticket obtained in S250 of FIG. 3 includes a setting value of an output medium setting. As described above, the output medium setting is a print setting that indicates a sheet size, that is, a media size.

FIG. 4 illustrates processing when a determination result in S420 is Yes. As described later, a job ticket that does not include the setting value of the media size may be obtained. Processing when the determination result in S420 is No will be described later.

When the job ticket includes a setting value for the media size (S420: Yes), both the document size associated with image data and the setting value of the output medium setting included in print settings indicate the media size of the page image. In S443A, the printer processor 110 causes the display 140 of the printer 100 of FIG. 1 to display a selection screen for selecting which media size to use.

FIG. 6 illustrates an example of the selection screen. The selection screen 800 includes two buttons 810 and 820. A first button 810 indicates a first setting, which indicates use of a document size of the image data. A second button 820 indicates a second setting, which indicates use of a media size of the print settings, namely a media size indicated by a setting value of the output medium setting included in the print settings. An explanation of each setting is displayed on the respective buttons 810 and 820.

A user can operate the first button 810 or the second button 820 by operating the operation unit 150 of the printer 100 of FIG. 1. In S445A of FIG. 4, it is assumed that the user selects the document size, that is, the first setting. Processes in a case where the second setting is selected will be described later.

The configuration of the selection screen may be any of various configurations that allow a user to select one of the first and second settings. For example, display of the explanations on the buttons 810 and 820 may be omitted. The selection screen 800 may include radio buttons instead of the buttons 810 and 820.

In S460 of FIG. 4, the printer processor 110 generates print data at the document size. The printer processor 110 uses the job ticket obtained in S250 of FIG. 3, that is the job ticket associated with the job ID obtained in S330, and image data obtained in S340. When the print mode is the pass-through mode, the image data is input image data. The printer processor 110 sets, for each page image, the media size to a media size indicated by the document size. In the present embodiment, the document size is represented by the image data. The printer processor 110 sets print settings other than the media size to print settings represented by the job ticket. For example, the color mode is set to a mode represented by the job ticket.

In S490, the printer processor 110 controls the printer engine 160 in accordance with the print data, thereby printing the respective page images. The printing process is then terminated.

FIG. 2B is a diagram illustrating an example of a printed material printed using the print data generated in S460 of FIG. 4. The printed material PD1 represents a printed material printed using the input image data DC1 of FIG. 2A. The printed material PD1 includes the media M11 and M12. The first page image IMG1 is printed on the medium M11, and the second page image IMG2 is printed on the medium M12. A size of the medium M11 representing the first page image IMG1 is the Letter size indicated by the media size PS1. A size of the medium M12 representing the second page image IMG2 is the A4 size indicated by the media size PS2. Thus, mixed-size printing is executed through document size printing.

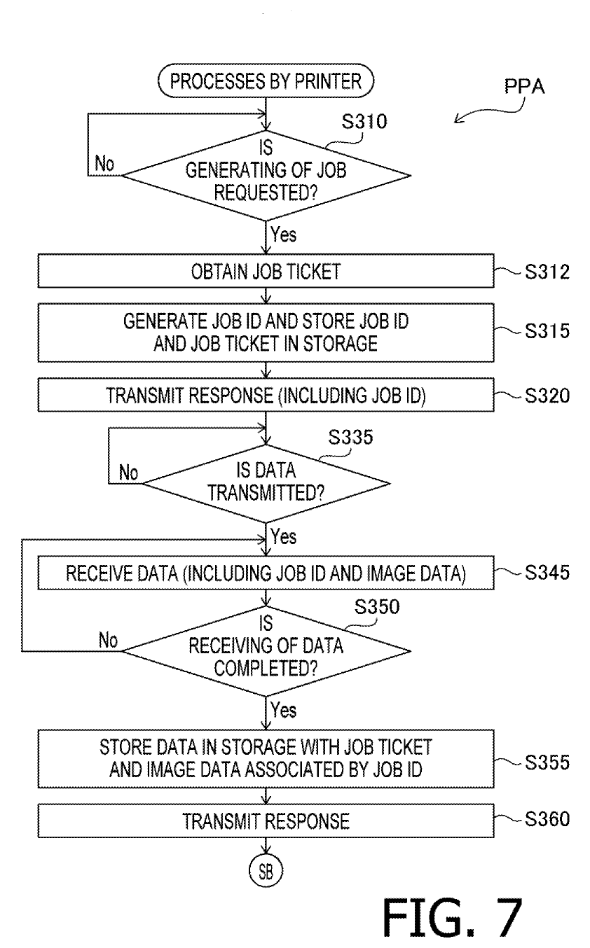

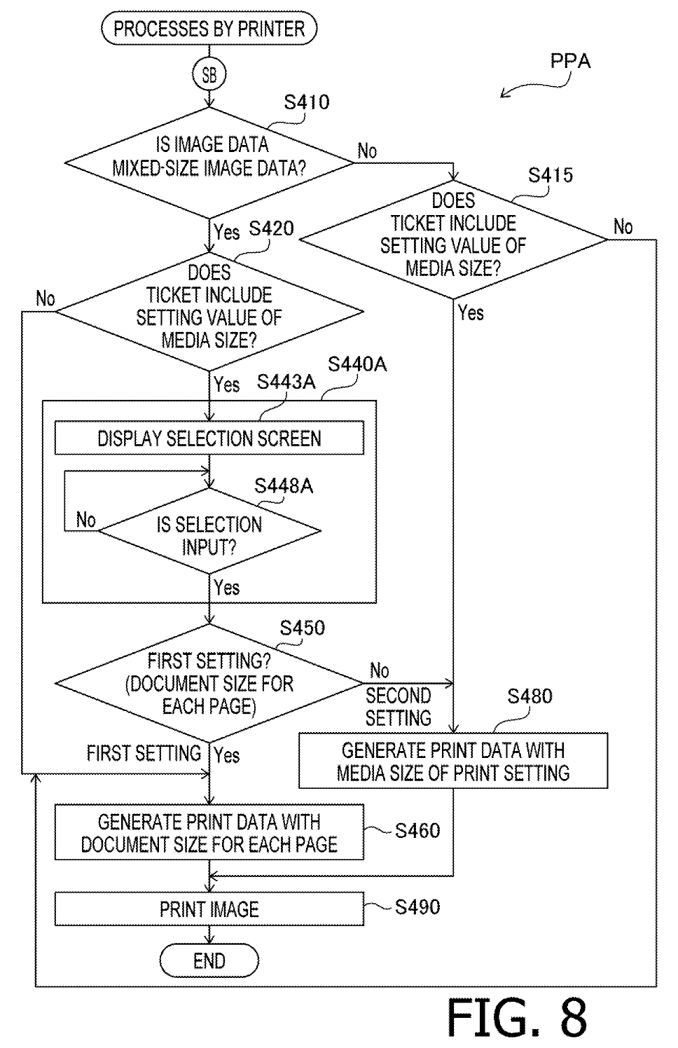

Note that FIGS. 3 and 4 illustrate processing executed when the determination results in S410 and S420 of FIG. 4 are each Yes. In practice, the determination result in S410 may be No, and the determination result in S420 may be No. The printer processor 110 executes various processes according to the determination results of S410 and S420. FIGS. 7 and 8 are flowcharts illustrating examples of processes executed by the printer processor 110. Hereinafter, the processes executed by the printer processor 110 are referred to as a “printer process.” The processes executed by the printer processor 110 in FIGS. 3 and 4 represent a part of the printer process PPA of FIGS. 7 and 8. In FIGS. 3 and 4, steps corresponding to those of FIGS. 7 and 8 are denoted by the same reference signs. For example, S315 of FIG. 3 corresponds to S315 of FIG. 7.

In S310 of FIG. 7, the processor 110 determines whether job generation is requested. When the job generation is not requested (S310: No), the processor 110 waits for a request for job generation.

When the job generation is requested as in S250 of FIG. 3 (FIG. 7: S310: Yes), in S312, the processor 110 obtains data of a job ticket associated with the request for job generation. As described with reference to S250 of FIG. 3, the data of the job ticket is transmitted to the printer 100 in association with the request for job generation.

In S315, the processor 110 generates a job ID associated with the job ticket. The processor 110 stores, in the storage 115, data of the job ticket in association with data of the job ID. The data may be stored, for example, in the non-volatile storage 130.

In S320, the processor 110 transmits to the terminal device 200 a response to the request for job generation. This response includes data of the job ID generated in S315.

In S335, the processor 110 determines whether data representing the job ID and image data are transmitted from the terminal device 200 to the printer 100. When the image data is not transmitted (S335: No), the processor 110 waits for transmission of the image data.

As in S330 and S340 of FIG. 3, when the data of the job ID and the image data are transmitted (FIG. 7: S335: Yes), in S345, the processor 110 receives the data.

In S350, the processor 110 determines whether reception of the data is complete. When the reception of the data is not complete (S350: No), the processor 110 continues reception of the data in S345 and waits until the reception is completed.

When the reception of the data is completed (S350: Yes), in S355, the processor 110 stores the received data in the storage 115. Here, the processor 110 stores the image data in the storage 115 in association with the job ticket associated with the job ID received in S345. The image data is stored, for example, in the non-volatile storage 130.

In S360, the processor 110 transmits to the terminal device 200 a response to the transmission of the data.

In S410 of FIG. 8, the processor 110 determines whether the image data is mixed-size image data.

When image data such as the input image data DC1 of FIG. 2(A) is processed, a determination result in S410 is Yes. When the determination result in S410 is Yes, in S420, the processor 110 determines whether the job ticket includes a setting value of a media size.

As described in S230 and S235 of FIG. 3, when print settings are set through a setting screen such as the print setting screen 900 of FIG. 5, the job ticket includes the setting value of the media size, and therefore a determination result in S420 is Yes.

When a determination result in S420 of FIG. 8 is Yes, the processor 110 executes processing of S440A. The S440A includes S443A and S448A. In S443A, as described for S443A of FIG. 4, the processor 110 causes the display 140 to display the selection screen 800 shown in FIG. 6. In S448A, the processor 110 determines whether a selection has been input. When no selection is input (S448A: No), the processor 110 waits for the input of the selection.

When a selection is input (S448A: Yes), in S450, the processor 110 determines whether the first setting has been selected.

When the first setting is selected (S450: Yes), in S460, the processor 110 generates print data in accordance with the document size for each page. In S490, the processor 110 controls the printer engine 160 in accordance with the print data, thereby printing respective page images. Thereafter, the printer process PPA is terminated. For example, when the input image data DC1 of FIG. 2A is used and the first setting is selected, the printed material PD1 of FIG. 2B is generated. After S490, the processor 110 proceeds to S310 of FIG. 7, and the processor 110 executes the printer process PPA of FIGS. 7 and 8 for each request for job generation.

When the second setting is selected through the selection screen 800 of FIG. 6 (FIG. 8: S450: No), in S480, the processor 110 generates print data using a media size indicated by the print settings. Unlike S460, in S480, the processor 110 sets all print settings to those represented by the job ticket. The processor 110 sets, for each page image, the media size to the media size indicated by a setting value of the output medium setting included in the job ticket. After S480, the processor 110 proceeds to S490.

FIG. 2C illustrates an example of a printed material printed using the print data generated in S480 of FIG. 8. The printed material PD2 represents a printed material printed using the input image data DC1 of FIG. 2A. Here, it is assumed that the setting value of the output medium setting included in the job ticket indicates the A4 size. The printed material PD2 includes the media M21 and M22 of A4 size. The first page image IMG1 is printed on the medium M21, and the second page image IMG2 is printed on the medium M22. Thus, all of the page images IMG1 and IMG2 are printed on media having the media size indicated by the setting value of the output medium setting.

When the media size indicated by the setting value of the output medium setting differs from the media size indicated by the document size, the processor 110 may enlarge or reduce a page image in such a manner that the page image fits within the media size indicated by the setting value of the output medium setting.

A determination result in S420 of FIG. 8 may be No in various cases. For example, the operating system P2OS of FIG. 1 may receive a print request without using a setting screen such as the print setting screen 900 of FIG. 5. In such a case, the job ticket may omit a setting value of the media size.

A method for receiving a print request without using a setting screen may be various. For example, the operating system P2OS may display, on the display 240, a printer area that is an area indicating the printer, such as an icon or a window. When an icon indicating input image data is dropped into the printer area, the operating system P2OS may receive a print request without using the print screen. In receiving such a print request, the operating system P2OS may instruct the class driver P2DV to perform printing using the input image data. In this case, the class driver P2DV may transmit to the printer 100 a job ticket representing standard print settings that do not include the output medium setting. Because the job ticket does not include the setting value of the media size in such a case, the determination result in S420 is No.

When the determination result in S420 is No, the processor 110 skips S440A and S450 and proceeds to S460. The processor 110 generates print data using the document size for each page.

The determination result in S410 of FIG. 8 may be No in various cases. For example, the same media size may be assigned to all page images of the PDF image data. In this case, the determination result in S410 is No.

Further, when a print mode is not the pass-through mode but is the client mode, the determination result in S410 may be No. In the client mode, in S240 of FIG. 3, the class driver P2DV generates PDL data. For example, the class driver P2DV may generate intermediate data using input image data and generate PDL data using the intermediate data. The intermediate data may be, for example, XPS data. The PDL data is generated in accordance with print settings received through the print setting screen 900 in S235 of FIG. 3. In S340 of FIG. 3, the class driver P2DV transmits the PDL data to the printer 100. The PDL data transmitted in S340 is an example of target image data that is the image data to be printed. Here, as the PDL data, image data that does not include data indicating a document size may be generated. In this case, the determination result in S410 of FIG. 8 is No. In addition, like PDF image data, the PDL data may indicate a document size for each page. Here, the PDL data may assign the same media size to all page images. In this case, the determination result in S410 of FIG. 8 is No.

When the determination result in S410 is No, in S415, the processor 110 determines whether the ticket includes a setting value for a media size. This determination method is the same as that in S420. When the determination result in S415 is No, the processor 110 proceeds to S460 and generates print data using a document size. When the determination result in S410 is No, the image data is not mixed-size data. In this case, in S460, the processor 110 sets a media size of each page image to the same media size indicated by the document size. When the document size is not associated with the image data (S410: No) and the job ticket does not include a setting value of the media size (S415: No), in S460, the processor 110 may set the media size of each page image to a standard media size.

When the determination result in S415 is Yes, the processor 110 proceeds to S480 and generates print data using the media size indicated by the print settings.

As described above, in the present embodiment, the printer 100 of FIG. 1 includes the printer engine 160 and the processor 110. The processor 110, in accordance with the program P1, executes the following processes. In S345 of FIG. 7, the processor 110 obtains image data representing one or more page images to be printed. In S312, the processor 110 obtains a job ticket. In the present embodiment, the job ticket represents print settings. As described with reference to FIG. 5, the print settings indicate one or more setting items for printing. The job ticket is an example of print setting information indicating one or more setting items for printing. In S440A of FIG. 8, as described with reference to FIG. 6, the processor 110 receives a selection as to which of the first setting and the second setting is to be used. The processor 110 that executes S440A is an example of a receiving unit that receives this selection.

When the mixed-size image data is obtained (FIG. 8: S410: Yes), the job ticket including a setting value of an output medium setting is obtained (S420: Yes), and the first setting is selected (S450: Yes), the processor 110 prints images on media by executing S460 and S490. Here, input image data DC1 of FIG. 2A may be used. In the present embodiment, the input image data DC1 includes document size data indicating media sizes PS1 and PS2 associated with the page images IMG1 and IMG2, respectively. The mixed-size image data is image data that represents two or more page images including a first page image IMG1 to which a first media size PS1 is associated and a second page image IMG2 to which a second media size PS2 different from the first media size PS1 is associated, such as the input image data DC1. The media sizes PS1 and PS2 may indicate various media sizes. The output medium setting is a setting item that indicates a media size common to the respective page images IMG1 and IMG2 to be printed. FIG. 2B illustrates an example of a printed material generated by executing S460 and S490 in the above case (S410: Yes, S420: Yes, S450: Yes). The processor 110 causes the printer engine 160 to print the first page image IMG1 on an output medium M11 having the first media size PS1 and to print the second page image IMG2 on an output medium M12 having the second media size PS2.

When the mixed-size image data is obtained (FIG. 8: S410: Yes), the job ticket including a setting value of the output medium setting is obtained (S420: Yes), and the second setting is selected (S450: No), the processor 110 prints images on media by executing S480 and S490. FIG. 2C illustrates an example of a printed material generated by executing S480 and S490 in the above case (S410: Yes, S420: Yes, S450: No). The processor 110 causes the printer engine 160 to print each of two or more page images IMG1 and IMG2 represented by the mixed-size image data on mutually different output media M21 and M22 that have the media size indicated by the setting value of the output medium setting. In the example of FIG. 2C, the media size indicated by the setting value of the output medium setting is A4 size.

The processor 110 that executes S410, S420, and S450 to S490 is an example of a printing controller that causes the printer engine 160 to execute printing based on the image data and on the job ticket, which is an example of print setting information.

When the mixed-size image data and the print setting information including the setting value of the output medium setting are obtained, one or both of the first media size PS1 associated with the first page image IMG1 and the second media size PS2 associated with the second page image IMG2 may differ from the media size indicated by the setting value of the output medium setting. According to the above configuration, the processor 110 can execute printing of an image on an output medium having a media size suitable for a selected one of the first setting and the second setting.

In the present embodiment, the processor 110 further controls printing as follows. When mixed-size image data is obtained (FIG. 8: S410: Yes) and print setting information that does not include the setting value of the output medium setting is obtained (S420: No), the processor 110 prints page images on media by executing S460 and S490. In this case, as in the example of FIG. 2B, the processor 110 causes the printer engine 160 to print the first page image IMG1 on the output medium M11 having the first media size PS1 and to print the second page image IMG2 on the output medium M12 having the second media size PS2. When the job ticket does not indicate a media size, it is highly likely that the user expects that the media size indicated by the document size, that is, the media size associated with a page image, will be used for printing. According to the above configuration, the processor 110 can execute printing of an image on an output medium having a media size that matches a user's intention.

In the present embodiment, the processor 110 further controls printing as follows. As described above, PDF image data may represent one or more equal-size page images, which are one or more page images associated with the same media size. Various kinds of PDL data, not limited to PDF image data, may represent one or more equal-size page images. Thus, the same media size may be associated with all page images. When such image data is obtained, the determination result in S410 of FIG. 8 is No. Further, when the job ticket including the setting value of the output medium setting is obtained (S415: Yes), the processor 110 causes page images to be printed on media by executing S480 and S490. In S480, regardless of whether a media size associated with one or more equal-size page images is the same as a media size indicated by the setting value of the job ticket, the processor 110 applies the media size indicated by the setting value of the job ticket to all page images. That is, the processor 110 causes the printer engine 160 to print each of the equal-size page images on mutually different output media having the media size indicated by the setting value of the job ticket. When the media size indicated by the setting value of the job ticket differs from the media size associated with the one or more equal-size page images, it is highly likely that the media size indicated by the setting value of the job ticket has been set by the user for printing. According to the above configuration, the processor 110 can execute printing of an image on an output medium having a media size that matches a user's intention.

In the present embodiment, the processor 110 executes the following processing in accordance with the program P1. When the mixed-size image data is obtained (FIG. 8: S410: Yes) and the job ticket including a setting value of an output medium setting is obtained (S420: Yes), in S440A, the processor 110 receives a selection as to which of the first setting and the second setting is to be used. In S450 to S490, the processor 110 causes the printer engine 160 to execute printing based on the selected setting. According to this configuration, the processor 110 can accept selection of either the first setting or the second setting for each print job. Accordingly, for each print job, the processor 110 can execute printing of an image on the output medium having a media size suitable for a user’s intention.

In the present embodiment, data used as the mixed-size image data includes data in Portable Document Format (PDF). As described in FIG. 2A, when the mixed-size image data is PDF data, a first media size PS1 associated with the first page image IMG1 and the second media size PS2 associated with a second page image IMG2 are represented by the PDF data. According to this configuration, the processor 110 can obtain a media size associated with a page image by using the PDF data.

In the present embodiment, as described in S320 of FIG. 7, the processor 110, in response to acquisition of a job ticket from the terminal device 200 (S312), transmits a job ID to the terminal device 200. The job ID is an example of setting identification information associated with the job ticket, which is an example of print setting information. In S345, the processor 110 obtains, from the terminal device 200, the job ID and image data associated with the job ID. According to this configuration, the processor 110 can obtain, using the job ID, an appropriate correspondence between the image data and the job ticket.

In the present embodiment, the system 1000 of FIG. 1 includes a printer 100 and a terminal device 200. An operating system P2OS including a class driver P2DV is installed in the terminal device 200. The class driver P2DV is an example of a standard driver for printing.

The terminal device 200, by functions provided by the class driver P2DV, comprises the following processing units. In S230 of FIG. 3, the processor 210 operates as a providing unit that provides a print setting screen 900.

In S235, the processor 210 operates as an input receiving unit that receives, on the print setting screen 900, input of one or more setting items for printing. The print setting screen 900 includes a menu 910. The menu 910 is an operation element for inputting an output medium setting, which is a setting item indicating a media size common to respective page images to be printed. Thus, the processor 210 receives input of the output medium setting. The print setting screen 900 is not provided with an operation element for inputting a media size for each page image. That is, the processor 210 does not receive input of a media size for each page image.

In S250, the processor 210 operates as a print setting information transmission unit that transmits to the printer 100 the job ticket, which is an example of print setting information indicating the one or more setting items that have been input. Here, the print setting information includes a setting value selected via the menu 910, that is, a setting value of the output medium setting.

In S340, the processor 210 operates as an image data transmission unit that transmits image data to the printer 100. For example, the input image data DC1 of FIG. 2A is transmitted to the printer 100.

The printer 100 includes the printer engine 160 and the processor 110. The processor 110, in accordance with the program P1, executes the various processes described above.

There are cases where the printer 100 receives mixed-size image data and print setting information including a setting value of the output medium setting. The input image data DC1 of FIG. 2A is an example of the mixed-size data. A sheet size selected via the menu 910 of FIG. 5 is an example of the setting value of the output medium setting. Here, one or both of the first media size PS1 associated with the first page image IMG1 and the second media size PS2 associated with the second page image IMG2 may differ from the media size indicated by the setting value of the output medium setting. According to the configuration described above, printing of an image is possible on an output medium having a media size suitable for the setting selected from among the first setting and the second setting.

In addition, when the print setting screen 900 does not receive input of a media size for each page image to be printed but receives input of an output medium setting, processing based on the print setting information may disallow printing at per page media sizes and may allow printing at a media size indicated by a setting value of the output medium setting. According to this configuration, by selection of the first setting, printing of the first page image IMG1 on the output medium M11 having the first media size PS1 and printing of the second page image IMG2 on the output medium M12 having the second media size PS2 are enabled.

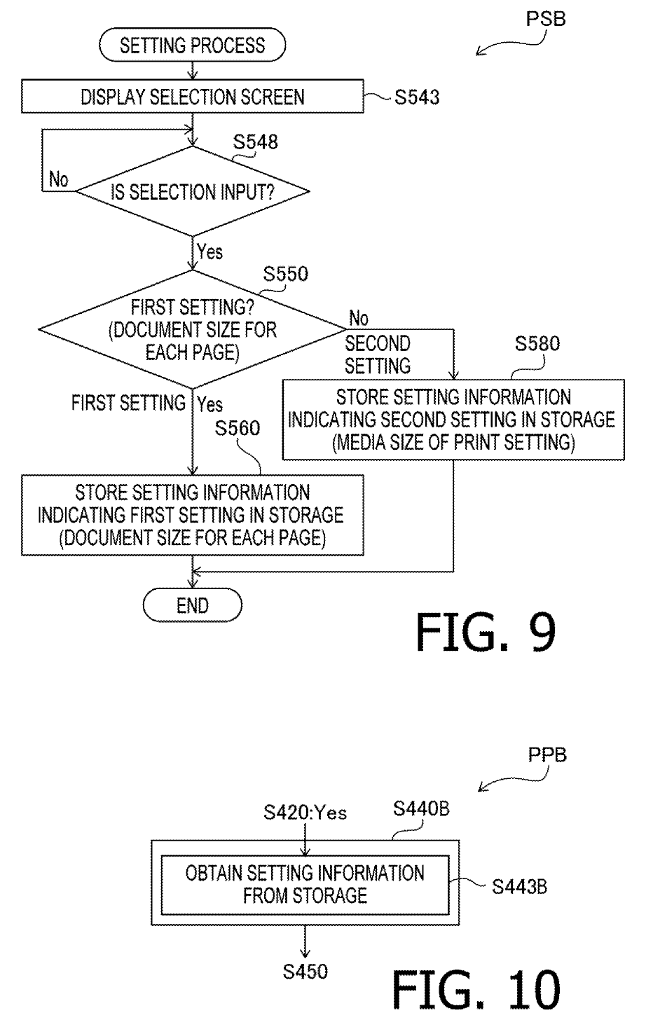

FIG. 9 is a flowchart illustrating an example of the setting process. A setting process PSB is a process for preliminarily selecting one of the first setting and the second setting described with reference to FIG. 6. As described later, in a printer process, a setting selected by the setting process PSB is used. The processor 110 of the printer 100 of FIG. 1 starts the setting process PSB in accordance with an instruction from the user.

In S543, the processor 110 causes the display 140 of FIG. 1 to display a selection screen. In the present embodiment, the processor 110 displays the selection screen 800 of FIG. 6. The configuration of the selection screen may be any of various configurations that allow a user to select one of the first setting and the second setting.

In S548, the processor 110 determines whether a selection has been input. When no selection is input (S548: No), the processor 110 waits for input of the selection.

When the selection is input (S548: Yes), in S550, the processor 110 determines whether the first setting is selected.

When the first setting is selected (S550: Yes), in S560, the processor 110 stores, in the storage 115, data of setting information indicating the first setting. In the present embodiment, the data of the setting information is stored in the non-volatile storage 130. The processor 110 then terminates the setting process PSB.

When the second setting is selected (S550: No), in S580, the processor 110 stores, in the non-volatile storage 130, data of setting information indicating the second setting. The processor 110 then terminates the setting process PSB.

It should be noted that the data of the setting information may be stored in the volatile storage 120.

FIG. 10 is a diagram illustrating an example of a printer process of the present embodiment. The only difference from the printer process PPA of FIGS. 7 and 8 is that S440A of FIG. 8 is replaced by S440B of FIG. 10. Other portions of the printer process PPB of the present embodiment are the same as corresponding portions of the printer process PPA of FIGS. 7 and 8.

When the determination result in S420 of FIG. 8 is Yes, the processor 110 of FIG. 1 executes S440B of FIG. 10. The S440B includes S443B. In S443B, the processor 110 obtains setting information from the non-volatile storage 130. The obtained setting information indicates the first setting or the second setting. After S440B, in S450 of FIG. 8, the processor 110 determines, with reference to the setting information obtained in S443B, whether the first setting is selected.

The processor 110 of the printer 100 shown in FIG. 1 executes the setting process PSB of FIG. 9 and the printer process PPB of FIG. 10 in accordance with a program stored in the non-volatile storage 130 of the printer 100. For example, the program P1 may be configured to cause the processor 110 to execute the setting process PSB and the printer process PPB.

As described above, in this embodiment, the printer 100 of FIG. 1 includes, in addition to the processor 110, the non-volatile storage 130 as an example of a memory. In S543 to S548 of FIG. 9, the processor 110 receives a selection as to which setting is to be used from among the first setting and the second setting. In S550 to S580, the processor 110 stores, in the non-volatile storage 130, setting information indicating the selected result. That is, the processor 110 stores the setting information in the non-volatile storage 130. The processor 110 that executes S543 to S580 is an example of a receiving unit.

In a case where the mixed-size image data is obtained (FIG. 8: S410: Yes) and the job ticket including a setting value of the output medium setting is obtained (S420: Yes), the processor 110 obtains the setting information in S440B of FIG. 10. In S450 of FIG. 8, the processor 110 makes a determination using the setting information.

When the setting information indicating the first setting is stored in the non-volatile storage 130 (FIG. 8: S450: Yes), the processor 110 executes S460 and S490. As described with reference to FIG. 2B, the processor 110 causes the printer engine 160 to print the first page image IMG1 on the output medium M11 having the first media size PS1, and causes the printer engine 160 to print the second page image IMG2 on the output medium M12 having the second media size PS2.

When the setting information indicating the second setting is stored in the non-volatile storage 130 (FIG. 8: S450: No), the processor 110 executes S480 and S490. As described with reference to FIG. 2C, the processor 110 causes the printer engine 160 to print each of the two or more page images IMG1 and IMG2 represented by the mixed-size image data on output media M21 and M22, which are output media having the media size indicated by the setting value of the output medium setting and which are different from each other.

Accordingly, because the processor 110 uses setting information indicating a setting selected from the first setting and the second setting in advance, a burden on the user is reduced as compared with a case in which the user selects the setting for each print job.

It should be noted that a printer process PPB of FIG. 10 in this embodiment is the same as the printer process PPA of FIGS. 7 and 8, except that S440A of FIG. 8 is replaced with S440B of FIG. 10. Accordingly, this embodiment can provide the same advantages as those provided by the first embodiment.

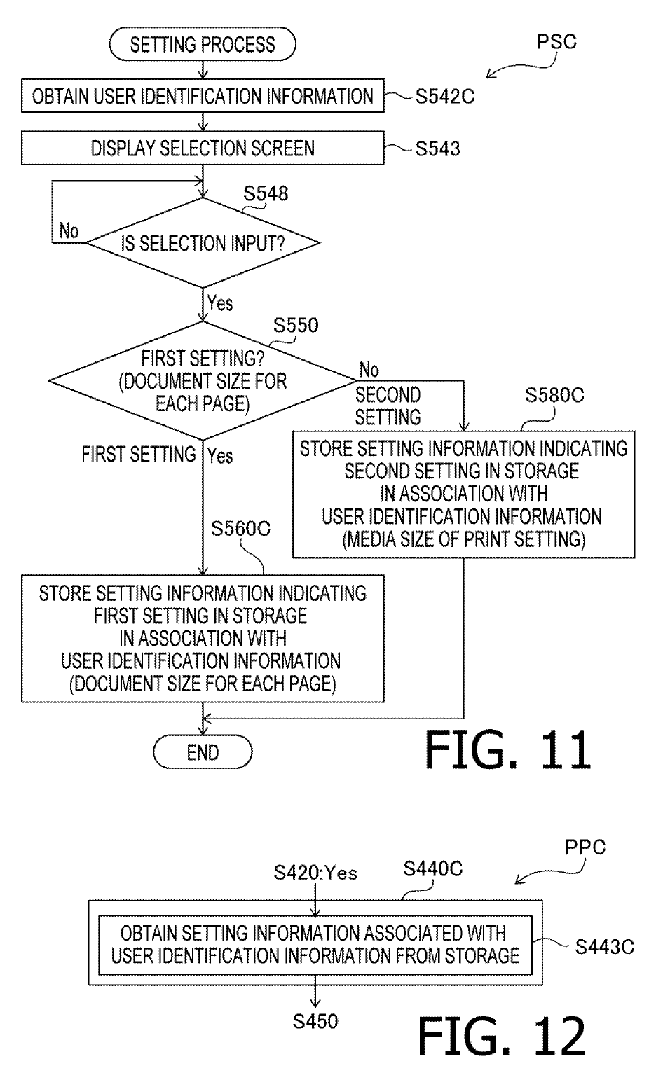

FIG. 11 is a flowchart illustrating another example of the setting process. A difference from the setting process PSB of FIG. 9 is that the setting information is recorded for each piece of user identification information. A setting process PSC of this embodiment is obtained by adding S542C before S543 in the setting process PSB of FIG. 9 and by respectively replacing S560 and S580 with S560C and S580C.

In S542C, the processor 110 obtains user identification information to be associated with the setting information. Various methods can be applied for obtaining the user identification information. For example, a user may input the user identification information by operating the operation unit 150 of the printer 100 of FIG. 1.

S543 to S550 are respectively the same as S543 to S550 of FIG. 9.

The processor 110 stores, in S560C, data of setting information indicating the first setting in the storage 115 in association with the user identification information obtained in S542C when the first setting is selected (S550: Yes). For example, data representing a set of the setting information and the user identification information is stored in the storage 115. In this embodiment, the data is stored in the non-volatile storage 130. Thereafter, the processor 110 terminates the setting process PSC.

When the second setting is selected (S550: No), the processor 110 stores, in S580C, data of setting information indicating the second setting in the non-volatile storage 130 in association with the user identification information obtained in S542C. For example, data representing a set of the setting information and the user identification information is stored in the non-volatile storage 130. Thereafter, the processor 110 terminates the setting process PSC.

FIG. 12 is a diagram illustrating an example of a printer process of this embodiment. The only difference from the printer process PPA of FIGS. 7 and 8 is that S440A of FIG. 8 is replaced with S440C of FIG. 12. Other portions of the printer process PPC of this embodiment are the same as the corresponding portions of the printer process PPA of FIGS. 7 and 8.

When a determination result in S420 of FIG. 8 is Yes, the processor 110 of FIG. 1 executes S440C of FIG. 12. The S440C includes S443C. In S443C, the processor 110 obtains, from the non-volatile storage 130, setting information associated with user identification information. As the user identification information, the user identification information included in the job ticket obtained in S312 of FIG. 7 is used. The obtained setting information indicates either the first setting or the second setting. After S440C, in S450 of FIG. 8, the processor 110 determines whether the first setting is selected with reference to the setting information obtained in S443C.

The printer 100 may be used by a plurality of users. The setting process PSC of FIG. 11 and the printer process PPC of FIG. 12 may be executed for each user.

The processor 110 of the printer 100 of FIG. 1 executes the setting process PSC of FIG. 11 and the printer process PPC of FIG. 12 in accordance with a program stored in the non-volatile storage 130 of the printer 100. For example, the program P1 may be configured to cause the processor 110 to execute the setting process PSC and the printer process PPC.

As described above, in the present embodiment, the printer 100 of FIG. 1 includes, in addition to the processor 110, the non-volatile storage 130 as an example of a memory. In S543 to S548 of FIG. 11, the processor 110 receives a selection as to which of the first setting and the second setting is to be used. In S542C, S550, S560C, and S580C, the processor 110 stores, in the non-volatile storage 130 in association with user identification information that identifies a user, setting information indicating a selection result; that is, the processor 110 causes the non-volatile storage 130 to store the setting information in association with the user identification information. The processor 110 that executes S542C, S543 to S550, S560C, and S580C is an example of a receiving unit.

In S312 of FIG. 7, the processor 110 obtains user identification information included in a job ticket. The obtained user identification information is an example of target user identification information, which is user identification information that identifies a target user associated with printing. The processor 110 that obtains the user identification information in S312 is an example of an identification information obtaining unit.

The processor 110 controls printing as follows. When mixed-size image data is obtained (FIG. 8: S410: Yes) and the job ticket including the setting value the output medium setting is obtained (S420: Yes), the processor 110 obtains, in S440C of FIG. 12, setting information associated with the target user identification information. In S450 of FIG. 8, the processor 110 makes a determination using the setting information.

When setting information indicating the first setting is stored in the non-volatile storage 130 in association with the target user identification information (FIG. 8: S450: Yes), the processor 110 executes S460 and S490. As described with reference to FIG. 2B, the processor 110 causes the printer engine 160 to print the first page image IMG1 on the output medium M11 of the first media size PS1 and to print the second page image IMG2 on the output medium M12 of the second media size PS2.

When setting information indicating the second setting in association with the target user identification information is stored in the non-volatile storage 130 (FIG. 8: S450: No), the processor 110 executes S480 and S490. As described with reference to FIG. 2C, the processor 110 causes the printer engine 160 to print each of two or more page images IMG1 and IMG2 represented by the mixed-size image data on output media M21 and M22 having the media size indicated by the setting value of the output medium setting, the respective output media being mutually different.

Thus, because the processor 110 uses setting information indicating a setting preselected from the first setting and the second setting, the burden on a user is reduced as compared with a case where the user selects the setting for each print job. The setting information is stored in the non-volatile storage 130 in association with user identification information, and, in printing, the setting information associated with the target user identification information is used. Accordingly, the processor 110 can execute printing in accordance with a setting suitable for the user.

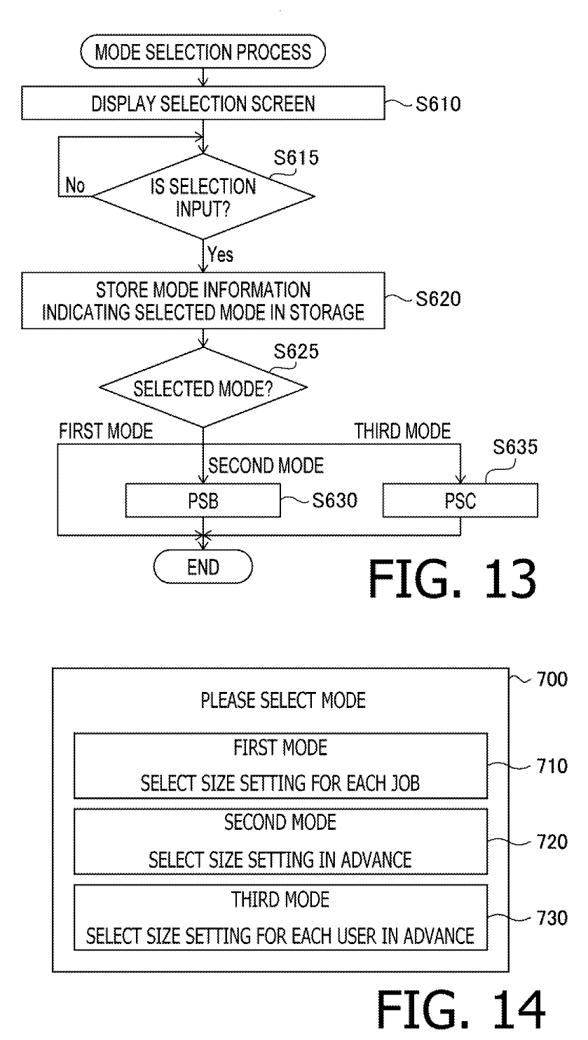

FIG. 13 is a flowchart illustrating an example of a mode selection process. In the present embodiment, an operation mode of the printer 100 of FIG. 1 is selected from three modes. A first mode is a mode for executing the printer process PPA of FIGS. 7 and 8. A second mode is a mode for executing the printer process PPB of FIG. 10. A third mode is a mode for executing the printer process PPC of FIG. 12. The processor 110 of the printer 100 of FIG. 1 starts the mode selection process in accordance with an instruction from a user.

In S610, the processor 110 causes the display 140 of the printer 100 of FIG. 1 to display a mode selection screen for selecting a mode.

FIG. 14 is a diagram illustrating an example of a mode selection screen. A mode selection screen 700 includes three buttons 710, 720, and 730. The first button 710 indicates the first mode, the second button 720 indicates the second mode, and the third button 730 indicates the third mode. A description of each mode is displayed on the respective buttons 710, 720, and 730.

A user can operate these buttons 710, 720, and 730 by operating the operation unit 150 of the printer 100.

A configuration of the selection screen may be various configurations that allow a user to select a mode. For example, display of the descriptions on the buttons 710, 720, and 730 may be omitted. The mode selection screen 700 may include radio buttons instead of the buttons 710, 720, and 730.

In S615 of FIG. 13, the processor 110 determines whether a selection has been input. When no selection is input (S615: No), the processor 110 waits for input of a selection.

When a selection is input (S615: Yes), in S620, the processor 110 stores, in the storage 115, data of mode information indicating the selected mode. In the present embodiment, the data of the mode information is stored in the non-volatile storage 130. However, the data of the mode information may be stored in the volatile storage 120.

In S625, the processor 110 branches processing in accordance with the selected mode. When the selected mode is the first mode, the mode selection process ends.

When the selected mode is the second mode, in S630, the processor 110 executes the setting process PSB of FIG. 9. The mode selection process then ends. The processor 110 may start the setting process PSB in response to an instruction from a user.

When the selected mode is the third mode, in S635, the processor 110 executes the setting process PSC of FIG. 11, and the mode selection process then ends. The processor 110 may start the setting process PSC in response to an instruction from a user. The processor 110 may also execute the setting process PSC for each of multiple users.

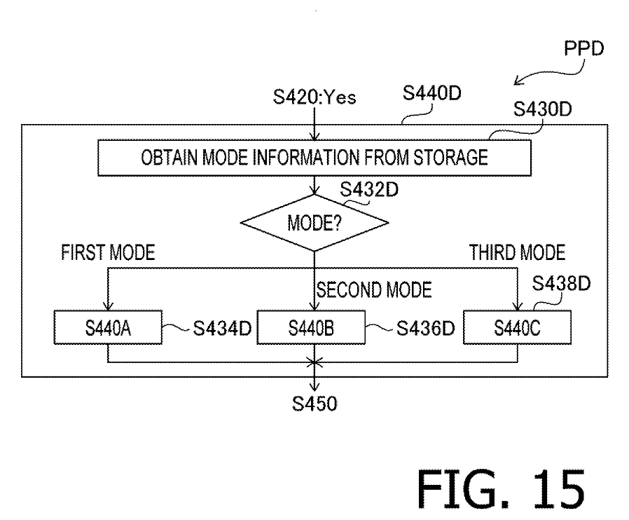

FIG. 15 is a diagram illustrating an example of a printer process according to the present embodiment. The only difference from the printer process PPA of FIGS. 7 and 8 is that S440A of FIG. 8 is replaced with S440D of FIG. 15. The other portions of processing of the printer process PPD of the present embodiment are the same as the corresponding portions of processing of the printer process PPA of FIGS. 7 and 8.

When a determination result in S420 of FIG. 8 is Yes, the processor 110 of FIG. 1 executes S440D of FIG. 15. S440D includes S430D, S432D, S434D, S436D, and S438D.

In S430D, the processor 110 obtains mode information from the non-volatile storage 130. In S432D, the processor 110 branches processing in accordance with the mode indicated by the mode information.

When the mode information indicates the first mode, in S434D, the processor 110 executes S440A shown in FIG. 8 and then proceeds to S450 of FIG. 8. Thus, when the mode information indicates the first mode, the processor 110 executes the same processing as the printer process PPA of FIGS. 7 and 8.

When the mode information indicates the second mode, in S436D of FIG. 15, the processor 110 executes S440B shown in FIG. 10 and then proceeds to S450 of FIG. 8. Thus, when the mode information indicates the second mode, the processor 110 executes the same processing as the printer process PPB described with reference to FIG. 10.

When the mode information indicates the third mode, in S438D of FIG. 15, the processor 110 executes S440C shown in FIG. 12 and then proceeds to S450 of FIG. 8. Thus, when the mode information indicates the third mode, the processor 110 executes the same processing as the printer process PPC described with reference to FIG. 12.

The processor 110 of the printer 100 of FIG. 1 executes the mode selection process of FIG. 13 and the printer process PPD of FIG. 15 in accordance with a program stored in the non-volatile storage 130 of the printer 100. For example, the program P1 may be configured to cause the processor 110 to execute the mode selection process and the printer process PPD.

As described above, in the present embodiment, the printer 100 of FIG. 1 includes, in addition to the processor 110, the non-volatile storage 130 as an example of a memory.

In steps S610 to S615 of FIG. 13, the processor 110 receives a selection as to which one of multiple modes, including the first mode and the second mode, is to be used. The processor 110 that executes steps S610 to S615 is an example of a mode selection unit. In this embodiment, at step S620, the processor 110 stores, in a non-volatile storage 130 as an example of a memory, mode information indicating a selection result. That is, the processor 110 causes the non-volatile storage 130 to store mode information representing the selection result of the mode. The mode information can be referenced by subsequent processing.

When the mode information indicates the first mode, i.e., when the first mode is selected, at step S434D of FIG. 15, the processor 110 executes step S440A shown in FIG. 8. That is, similar to the embodiments of FIGS. 7 and 8, the processor 110 performs the same processing as a printer process PPA.

When the mode information indicates the second mode, i.e., when the second mode is selected, at step S630 of FIG. 13, the processor 110 executes the setting process PSB as in the embodiment of FIG. 9.

Additionally, when the second mode is selected, at step S436D of FIG. 15, the processor 110 executes step S440B of FIG. 10. That is, similar to the embodiment of FIG. 10, the processor 110 performs the same processing as a printer process PPB.

Accordingly, when the first mode is selected, similar to the embodiments of FIGS. 7 and 8, the processor 110 can receive, for each print job, a selection between the first setting and the second setting. Therefore, for each print job, the processor 110 can cause to print images onto an output medium having a media size suited to user intent. Further, when the second mode is selected, similar to the embodiments of FIGS. 9 and 10, the processor 110 uses setting information indicating a setting preselected from the first setting and the second setting. Thus, compared with a case in which a user selects the setting for each print job, user burden is reduced.

When the third mode is selected, at step S635 of FIG. 13, the processor 110 executes the setting process PSC as in the embodiment of FIG. 11. In addition, at step S438D of FIG. 15, the processor 110 executes step S440C of FIG. 12. That is, similar to the embodiment of FIG. 12, the processor 110 performs the same processing as a printer process PPC. In this way, because the processor 110 uses setting information indicating a setting preselected from the first setting and the second setting, user burden is reduced. The processor 110 can also perform printing in accordance with settings suitable for the user.

### E. Modifications

Various modifications described below can be applied to the embodiments above.
(1) A document size that indicates a media size associated with a page image may be represented not by the image data itself but by other data associated with the image data. For example, metadata representing attribute information about the image data may represent the document size. In this case, in the processes of FIGS. 3–4, 7-8, 10, 12, and 15, a set of the image data and the metadata is processed instead of the image data alone. For example, at step S340 of FIG. 3, a class driver P2DV transmits to a printer 100 a dataset including the image data and the metadata.
In any case, the document size may be various media sizes associated with the image data without using a print setting screen. There are various methods of associating a media size with image data without going through the print setting screen. For example, an application that edits data representing page images, such as PDF image data or document data, may assign a media size to each page image.
(2) The conditions for the determinations in steps S415 and S420 of FIG. 8 may be various conditions indicating that print setting information including a value of an output medium setting has been obtained. Here, the output medium setting is a setting item indicating a media size common to the page images to be printed. For example, print setting information representing print settings, such as a job ticket, may indicate that the value of the output medium setting is omitted or that the value is not set. In such a case, the processor 110 may determine that print setting information including a value of the output medium setting has not been obtained. Moreover, print setting information that does not include a setting item indicating the output medium setting may be obtained. In this case as well, the processor 110 may determine that print setting information including a value of the output medium setting has not been obtained.
(3) In the embodiments of FIGS. 13, 14, and 15, one mode arbitrarily preselected from the first mode, the second mode, and the third mode may be omitted. For example, the first mode may be omitted and the second mode and the third mode may be selectable. The second mode may be omitted and the first mode and the third mode are selectable. The third mode may be omitted such that the first mode and the second mode are selectable.
(4) Processing executed by the printer 100 is not limited to the processing in the above embodiments and modifications, and may take various forms. For example, when the determination result in S410 in FIG. 8 is No and the determination result in S415 is Yes, the processor 110 may branch the processing depending on whether the image data includes data indicating a document size. When the image data includes data indicating the document size, the processor 110 may proceed to S460; when the image data does not include data indicating the document size, the processor 110 may proceed to S480.
(5) A method of receiving size setting selection, which is a selection of which of the first setting and the second setting is to be used, is not limited to the methods of the above embodiments and modifications, and may be any of various methods. For example, the program P1 of the printer 100 may be configured to cause the processor 110 to implement a web server function that provides a web page for entering various settings including the size setting selection. A user may input the size setting selection through the web page by operating a web browser or a dedicated application on a terminal device capable of communicating with the printer 100.
Similarly, a method of receiving mode selection, which is a selection of which of multiple modes is to be used, may be any of various methods. For example, the mode selection may be input through a web page provided by the printer 100. Note that selection of the mode may be disallowed to general users of the printer 100 and may be permitted to an administrative user who manages the printer 100.
(6) A configuration of the print setting screen is not limited to the configuration of FIG. 5 and may be any of various configurations. For example, multiple options for the media size may be represented by radio buttons. In any case, the print setting screen may be configured to receive input of an output medium setting, which is a setting item indicating a media size common to the respective page images to be printed, without receiving input of a media size for each of the page images to be printed.
(7) A total number of page images represented by the image data may be any number of one or more.
(8) A total number of media sizes usable by the printer engine 160 may be any of various numbers of two or more. For example, the printer engine 160 may include three trays for three media sizes of A4, Letter, and A5. As the medium, various sheets such as paper and film may be usable.
(9) Input image data used for the printing processing may be any image data instead of PDF image data. For example, a document edited by a word processor application may be printed. In this case, the printing processing may proceed in the client mode. Here, a document representing multiple page images with mixed media sizes may be edited by the word processor application. The PDL data generated by the printing processing may represent multiple page images with mixed media sizes.
(10) Image data transmitted to the printer 100 by the terminal device 200 is not limited to PDF data and PDL data, and may be any of various kinds of image data. For example, the class driver P2DV may generate raster data using input image data and may transmit the raster data to the printer 100. The printer processor 110 may generate print data using the raster data.
(11) Various kinds of image data, not limited to PDF data, may form mixed-size image data. For example, various kinds of PDL data may form mixed-size image data. Further, raster data may form mixed-size image data.
(12) The communication processing between the printer 100 and the terminal device 200 is not limited to the processes described with reference to FIGS. 3 and 7, and may be any process for transmitting print setting information and image data to the printer 100. For example, a data set including data representing the print setting information and the image data may be transmitted to the printer 100 without using setting identification information such as a job ID.
(13) The communication method between the printer 100 and the terminal device 200 may be any method other than using the network NT. For example, the printer 100 and the terminal device 200 may communicate by short-range wireless communication such as Bluetooth (registered trademark) or NFC (Near Field Communication). The printer 100 and the terminal device 200 may communicate via a USB cable (not shown). The printer 100 and the terminal device 200 may communicate via a remote print server (not shown).
(14) The class driver P2DV may receive the print request without using a print setting screen such as the print setting screen 900 shown in FIG. 5. In response to such a print request, the class driver P2DV may transmit to the printer 100 a job ticket that does not include print settings; that is, the class driver P2DV may transmit to the printer 100 a print request that does not include print settings. In this case, at S415 and S420 of FIG. 8, the processor 110 may determine that print setting information including a setting value of the output medium setting has not been obtained.
(15) In the terminal device 200, instead of a standard driver common to multiple types of printers provided by different manufacturers such as the class driver P2DV, a processor 210 may execute processing for printing in accordance with a dedicated printer driver for the printer 100.
(16) The terminal device 200 of FIG. 1 may be a device different from a personal computer, such as a digital camera or a scanner. In addition, the configuration of a printer is not limited to the configuration of the printer 100 of FIG. 1, and may be various configurations including a printing execution unit that is a device for performing printing and a processing unit that performs processing for printing. For example, the scanner engine 170 may be omitted.

In the above embodiments, part of a configuration implemented by hardware may be replaced with software, and conversely, part or all of a configuration implemented by software may be replaced with hardware. For example, processing executed by the printer processor 110 may be executed by dedicated hardware circuitry such as an Application Specific Integrated Circuit (ASIC).

In addition, when some or all of the functions of the present disclosure are implemented by a computer program, the program can be provided in a form stored in a non-transitory computer-readable recording medium. The program may be used in a state stored in the same or a different computer-readable recording medium from that at the time of provision. The “computer-readable recording medium” is not limited to portable recording media such as a memory card or a CD ROM, and may also include an internal storage device in a computer such as various ROMs, and an external storage device connected to a computer such as a hard disk drive.

The above embodiments and variations may be combined as appropriate. The above embodiments and variations are provided to facilitate understanding of the disclosure and are not intended to limit the invention. The invention may be modified and improved without departing from the spirit and scope thereof, and equivalents are included in the invention.

What is claimed is:

1. A printing apparatus comprising:
a printer engine;
an image data obtaining unit configured to obtain image data representing one or more page images to be printed;
a print setting information obtaining unit configured to obtain print setting information indicating one or more setting items for printing;
a receiving unit configured to receive a selection of which setting is to be used among a first setting and a second setting; and
a printing controller configured to cause the printer engine to execute printing based on the image data and the print setting information,
wherein, in a case where mixed-size image data and the print setting information are obtained and the first setting is selected, the mixed-size image data being the image data representing two or more page images including a first page image associated with a first media size and a second page image associated with a second media size different from the first media size, the print setting information including a setting value of an output medium setting, which is a setting item indicating a media size common to respective page images to be printed, the printing controller causes the printer engine to print the first page image on an output medium of the first media size and to print the second page image on an output medium of the second media size, and
wherein, in a case where the mixed-size image data and the print setting information are obtained and the second setting is selected, the print setting information including the setting value of the output medium setting, the printing controller causes the printer engine to print each of the two or more page images represented by the mixed-size image data on respective output media of the media size indicated by the setting value of the output medium setting, the respective output media being mutually different.

2. The printing apparatus according to claim 1,
wherein, in a case where the mixed-size image data and the print setting information not including the setting value of the output medium setting are obtained, the printing controller causes the printer engine to print the first page image on the output medium of the first media size and to print the second page image on the output medium of the second media size.

3. The printing apparatus according to claim 1,
wherein, in a case where the image data representing one or more equal-size page images, which are the one or more page images associated with a same media size, and the print setting information including the setting value of the output medium setting are obtained, the printing controller causes the printer engine to print each of the one or more equal-size page images on the respective output media of the media size indicated by the setting value of the output medium setting regardless of whether the media size associated with the one or more equal-size page images is the same as the media size indicated by the setting value of the output medium setting.

4. The printing apparatus according to claim 1,
wherein, in a case where the mixed-size image data and the print setting information including the setting value of the output medium setting are obtained, the receiving unit receives a selection of which setting is to be used among the first setting and the second setting, and
wherein the printing controller causes the printer engine to execute printing based on the selected setting.

5. The printing apparatus according to claim 1, further comprising a memory,
wherein the receiving unit is configured to receive a selection as to which of the first setting and the second setting is to be used and to store setting information indicating a selection result in the memory before the mixed-size image data and the print setting information are obtained, and
wherein, in a case where the mixed-size image data and the print setting information including the setting value of the output medium setting are obtained, the printing controller is configured to:
when the setting information indicating the first setting is stored in the memory, cause the printer engine to print the first page image on the output medium of the first media size and to print the second page image on the output medium of the second media size; and
when the setting information indicating the second setting is stored in the memory, cause the printer engine to print each of the two or more page images represented by the mixed-size image data respectively on the respective output media of the media size indicated by the setting value of the output medium setting.

6. The printing apparatus of claim 1, further comprising a memory,
wherein the receiving unit is configured to receive a selection as to which one of the first setting and the second setting is to be used and to store setting information indicating a selection result in the memory in association with user identification information identifying a user before the mixed-size image data and the print setting information are obtained,
wherein the printing apparatus further comprises an identification information obtaining unit configured to obtain target user identification information that is the user identification information identifying a target user associated with printing; and
wherein, in a case where the mixed-size image data and the print setting information including the setting value of the output medium setting are obtained, the printing controller is configured to:
when the setting information indicating the first setting in association with the target user identification information is stored in the memory, cause the printer engine to print the first page image on the output medium of the first media size and cause the printer engine to print the second page image on the output medium of the second media size; and
when the setting information indicating the second setting in association with the target user identification information is stored in the memory, cause the printer engine to print each of the two or more page images represented by the mixed-size image data on the respective output media of the media size indicated by the setting value of the output medium setting.

7. The printing apparatus according to of claim 1, further comprising:
a memory; and
a mode selection unit configured to receive a selection as to which mode is to be used among a plurality of modes including a first mode and a second mode;
wherein, in a state where the first mode is selected:
a receiving unit receives, when the mixed-size image data and the print setting information including the setting value of the output medium setting are obtained, a selection as to which of the first setting and the second setting is to be used; and
a printing controller causes the printer engine to execute printing based on the selected setting; and
wherein, in a state where the second mode is selected:
the receiving unit receives a selection as to which of the first setting and the second setting is to be used and store setting information indicating a selection result in the memory before the mixed-size image data and the print setting information are obtained, and
when the mixed-size image data and the print setting information including the setting value of the output medium setting are obtained, the printing controller is configured to:
when the setting information indicating the first setting is stored in the memory, causes the printer engine to print a first page image on an output medium of the first media size and to print a second page image on an output medium of the second media size; and
when the setting information indicating the second setting is stored in the memory, causes the printer engine to print, for each of two or more page images represented by the mixed-size image data, on the respective output media that are output media having a media size indicated by the setting value of the output medium setting.

8. The printing apparatus according to claim 1,
wherein the mixed-size image data is Portable Document Format data, and
wherein the first media size associated with the first page image and the second media size associated with the second page image are represented by the Portable Document Format data.

9. The printing apparatus according to claim 1, further comprising a transmitting unit configured to, in response to obtaining the print setting information from a terminal device, transmit to the terminal device setting identification information associated with the print setting information, and
wherein the image data obtaining unit is configured to obtain, from the terminal device, the setting identification information and image data associated with the setting identification information.

10. A printing method for printing using a printing apparatus, comprising:
obtaining image data representing one or more page images to be printed;
obtaining print setting information indicating one or more setting items for printing;
receiving a selection of which setting is to be used among a first setting and a second setting;
causing a printer engine of the printing apparatus to execute printing based on the image data and the print setting information;
in a case where mixed-size image data and the print setting information are obtained and the first setting is selected, the mixed-size image data being the image data representing two or more page images including a first page image associated with a first media size and a second page image associated with a second media size different from the first media size, the print setting information including a setting value of an output medium setting, which is a setting item indicating a media size common to respective page images to be printed, causing the printer engine to print the first page image on an output medium of the first media size and to print the second page image on an output medium of the second media size; and
in a case where the mixed-size image data and the print setting information including the setting value of the output medium setting are obtained and the second setting is selected, causing the printer engine to print each of the two or more page images represented by the mixed-size image data respectively on respective output media of the media size indicated by the setting value of the output medium setting, the respective output media being mutually different.

11. A printing system comprising, a printing apparatus and a terminal device,
wherein an operating system including a standard driver for printing is installed in the terminal device,
wherein the terminal device, by the standard driver, realizes functions of:
a providing unit configured to provide a print setting screen;
an input receiving unit configured to receive, in the print setting screen, input of one or more setting items for printing, the input receiving unit being configured not to receive input of a media size for each page image to be printed and configure to receive input of an output medium setting which is a setting item indicating a media size common to respective page images to be printed;
a print setting information transmitting unit configured to transmit print setting information indicating the one or more input setting items to the printing apparatus, the print setting information including a setting value of the output medium setting; and
an image data transmitting unit configured to transmit image data representing one or more page images to be printed to the printing apparatus;
wherein the printing apparatus comprises:
a printer engine;
a receiving unit configured to receive a selection of which setting is to be used among a first setting and a second setting; and
a printing controller configured to cause the printer engine to execute printing based on the image data and the print setting information received from the terminal device,
wherein, in a case where mixed-size image data and the print setting information are obtained and the first setting is selected, the mixed-size image data being the image data representing two or more page images including a first page image associated with a first media size and a second page image associated with a second media size different from the first media size, the print setting information including the setting value of the output medium setting, the printing controller causes the printer engine to print the first page image on an output medium of the first media size and to print the second page image on an output medium of the second media size, and
wherein, in a case where the mixed-size image data and the print setting information are obtained and the second setting is selected, the print setting information including the setting value of the output medium setting, the printing controller causes the printer engine to print each of the two or more page images represented by the mixed-size image data respectively on respective output media of the media size indicated by the setting value of the output medium setting, the respective output media being mutually different.
